(19) United States
(12) Patent Application Publication
(10) Pub. No.: US 2007/0122329 A1
(43) Pub. Date: May 31, 2007

(54) PURIFICATION OF RAW HYDROGEN

(76) Inventors: Alain Briglia, Corze (FR); Frederic Judas, Houston, TX (US); Michael A. Turney, Houston, TX (US)

Correspondence Address: Ms. Linda K. Russell, Air Liquide Intellectual Property Dept., 2700 Post Oak Blvd., Suite 1800, Houston, TX, 77056, US

(21) Appl. No.: 11/279,499

(22) Filed: Apr. 12, 2006

Related U.S. Application Data
(60) Provisional application No. 60/741,097, filed on Nov. 30, 2005.

(51) Int. Cl. C01B 3/52; B01J 19/00

(52) U.S. Cl. 423/238; 423/240 R; 423/658.3; 422/190

(57) ABSTRACT

Method and system for removing impurities such as chlorine, chloramines, and ammonia from a hydrogen gas. One embodiment of the invention provides for passing the hydrogen gas through a first scrubbing unit having a reducing agent in solution to at least partially remove chlorine and chloramines from the hydrogen gas. The hydrogen gas may be passed from the first scrubbing unit through a second scrubbing unit having an acid in solution to at least partially remove ammonia from the hydrogen gas.

### CROSS-REFERENCE TO RELATED APPLICATIONS

This application claims the benefit under 35 U.S.C. § 119(e) to provisional application No. 60/741,097, filed Nov. 30, 2005, the entire contents of which are incorporated herein by reference.

### BACKGROUND

Hydrogen gas can be produced by various processes including the use of steam methane reformers, electrolysis of water, and as a waste gas from chlorine production by electrolysis of an alkali metal chloride solution. The raw hydrogen gas produced by electrolysis of an alkali metal chloride solution often includes impurities such as chlorine (Cl₂) and ammonia (NH₃). The ammonia impurities are often a result of residue from explosives used in the salt mining process used to obtain the alkali metal chloride. The concentration of chlorine may be as high as tens of parts per million (ppm) while the concentration of ammonia may be as high as hundreds of ppm.

Chlorine and ammonia by themselves may cause adverse effects to downstream processes and equipment, such as poisoning of catalysts, destruction of absorbents, and corrosion. When combined, chlorine and ammonia form chloramines, such as monochloramine (NH₂Cl), dichloramine (NHCl₂), and trichloramine (NCl₃). The chloramines are highly unstable chemicals which may, as the concentration of the chloramines accumulates and exceeds at least 3%, decompose violently, leading to explosions. Purification of hydrogen gas by using adsorbents, such as activated carbon, promotes the formation and hazardous accumulation of chloramines.

Therefore, a need exists for a method and apparatus for removing the chlorine, chloramines, and ammonia from a hydrogen gas stream that is both cost efficient and safe.

### SUMMARY

The embodiments of the present invention generally provide a method for removing chlorine, chloramines and ammonia from a hydrogen gas stream. One embodiment of the invention provides a method for removing impurities from hydrogen gas by passing the hydrogen gas through a first scrubbing unit containing a reducing agent in solution to remove chlorine and chloramines from the hydrogen gas. The first scrubbing unit has a first inlet for receiving the hydrogen gas and a first enclosure in which the hydrogen gas contacts the solution with the reducing agent. The hydrogen gas may then be passed from the first scrubbing unit through a second scrubbing unit containing an acid in solution to remove ammonia from the hydrogen gas. The second scrubbing unit has a second inlet for receiving the hydrogen gas and a second enclosure in which the hydrogen gas contacts the solution with the acid. The hydrogen may further go through an acid removal process by passing the hydrogen gas from the second scrubbing unit through a third scrubbing unit containing water to remove acid traces from the hydrogen gas. The third scrubbing unit has a third inlet for receiving the hydrogen gas and a third enclosure in which the hydrogen gas contacts the water.

Another embodiment of the invention provides a method for removing impurities from hydrogen gas by contacting the hydrogen gas with a reducing agent in aqueous solution to remove chlorine and chloramines from the hydrogen gas, wherein the reducing agent is selected from the group consisting of sodium metabisulfite, sodium sulfite, and sodium hyposulfite. After the chlorine and chloramines removal, the hydrogen gas may be contacted with an acid in aqueous solution to remove ammonia from the hydrogen gas. The acid is selected from the group consisting of sulfuric acid and phosphoric acid. The hydrogen gas may, after the ammonia removal, be contacted with demineralized water to remove acid traces from the hydrogen gas.

Another embodiment of the invention provides a method for removing chlorine, chloramines, and ammonia impurities from hydrogen gas by contacting the hydrogen gas with an aqueous sodium hyposulfite solution to remove chlorine and chloramines from the hydrogen gas, passing the hydrogen gas after chlorine and chloramines removal through a first demister pad, after passing through the first demister pad, contacting the hydrogen gas with an aqueous sulfuric acid solution to remove ammonia from the hydrogen gas, passing the hydrogen gas after ammonia removal through a second demister pad, after passing through the second demister pad, contacting the hydrogen gas with demineralized water to remove acid from the hydrogen gas, and passing the hydrogen gas after acid removal through a third demister pad. In one embodiment, after passing the third demister pad the hydrogen gas comprises about 0.01 parts per million or less of chlorine, about 0.01 parts per million or less of chloramines, and about 0.1 parts per million or less of ammonia.

Another embodiment of the invention provides a system for removing chlorine, chloramines, and ammonia impurities from hydrogen gas. The system has a chlorine and chloramines scrubbing unit, an ammonia scrubbing unit, and an optional acid scrubbing unit. Each scrubbing unit has a packing material, a hydrogen gas inlet tip or diffuser, a liquid distributor directing either a reducing agent in aqueous solution, an acid in aqueous solution, or water onto the packing material. The hydrogen is contacted with the reducing agent, acid, and water to respectively remove chlorine and chloramines, ammonia, and acid from the hydrogen gas.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 illustrates a flow chart of a process for removing chlorine, chloramines, and ammonia from a stream of hydrogen gas, according to one embodiment of the invention;

FIG. 2 illustrates the processing units for the removal chlorine, chloramines, and ammonia, according to one embodiment of the invention;

FIG. 3 illustrates the processing unit for the removal of chlorine and chloramines, according to one embodiment of the invention;

FIG. 4 illustrates the processing unit for the removal of ammonia, according to one embodiment of the invention; and

FIG. 5 illustrates the processing unit for the removal of acid, according to one embodiment of the invention.

### DESCRIPTION OF PREFERRED EMBODIMENTS

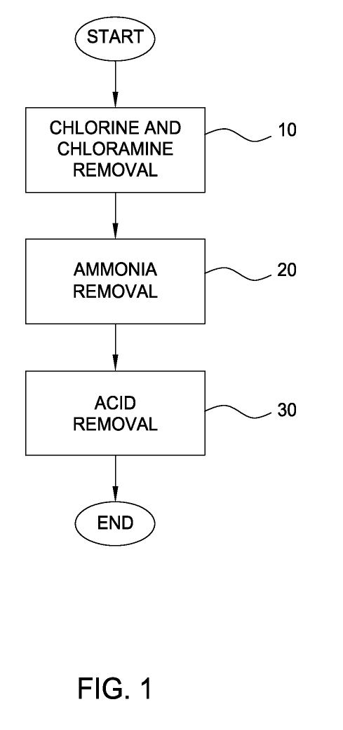

FIG. 1 illustrates a flow chart of a process 100 for removing chlorine, chloramines, and ammonia from a stream of hydrogen gas, according to one embodiment of the invention. Process 100 includes a chlorine and chloramines removal process 10, an ammonia removal process 20, and an acid removal process 30.

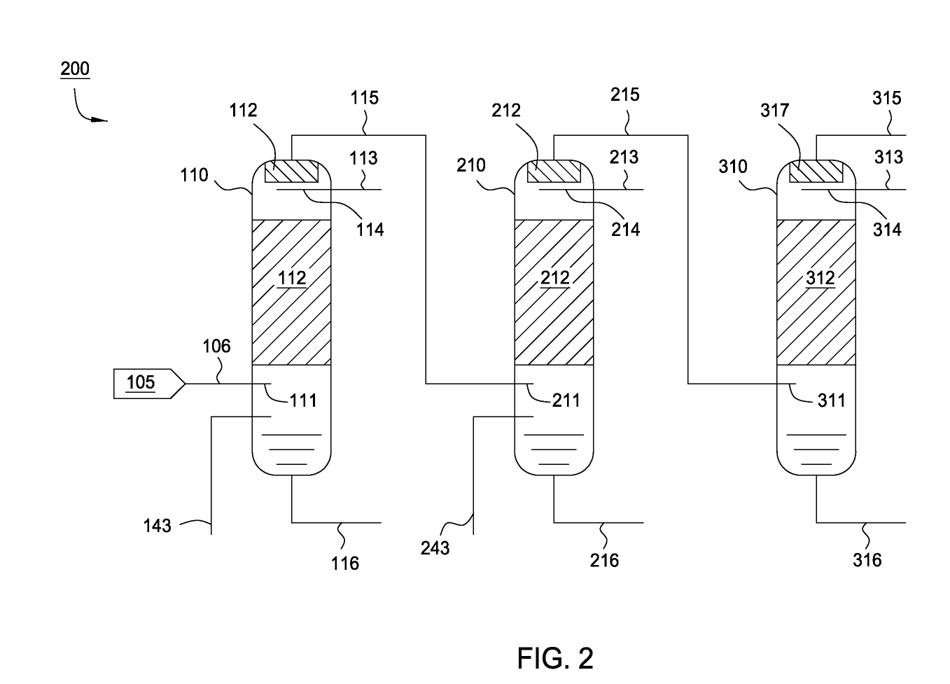

FIG. 2 illustrates a system 200 depicting the processing units in which process 100 takes place, according to one embodiment of the invention. Hydrogen gas is supplied from hydrogen gas source 105 through supply line 106 to scrubbing unit 110 where process 10 takes place.

In chlorine and chloramines removal process 10 the hydrogen gas is flowed into contact with an aqueous solution of a reducing agent. The reducing agent may be any compound that will reduce the chlorine gas to chloride ion, and combine with chloramines to form stable, harmless compounds. In one embodiment, the reducing agent is a sulfite, such as sodium metabisulfite (Na₂S₂O₅), sodium sulfite (Na₂SO₃), and/or sodium hyposulfite (Na₂S₂O₃). The reducing agent solution may have a concentration of about 20 mole % or less, such as in the range between about 0.01 mole % and about 20 mole %, and more preferably, between about 0.1 mole % and about 10 mole %. In one embodiment the reducing agent concentration is about 0.5 mole %. The optimal concentration may be determined by the maximum (peak) concentration of chlorine and chloramines in the hydrogen feed gas. The reducing agent solution is introduced into scrubbing unit 110 through supply line 113 and liquid distributor 114. The liquid distributor 114 directs the reducing agent solution onto a packing material 112. Packing material 112 provides increased surface area for the reaction and increases the rate of diffusion of the chloramines and chlorine in the hydrogen gas into the reducing agent solution. Packing material 112 may be of any shape, and made from metals, metal alloys, or polymers. In one embodiment packing material 112 consists of rings made from polypropylene with diameters in the range between about 1 inch and about 3 inches. In a particular embodiment, the diameter is about 2 inches. The hydrogen gas is introduced into the scrubbing unit 110 through inlet tip 111. In one embodiment, inlet tip 111 may be in the form of a diffuser. The pressure of the hydrogen gas as it enters scrubbing unit 110 may be between about 1 bar absolute and about 3 bar absolute. In one embodiment the pressure is about 1.7 bars absolute. The flow rate of the hydrogen gas is between about 40 kg/hour and about 1800 kg/hour, preferably, between about 400 kg/hour and about 1200 kg/hour. In one embodiment the flow rate is about 620 kg/hour. The hydrogen gas flows through the packing material 112 and comes into contact with the reducing agent solution so that the chloramines and chlorine gases flowing with the hydrogen gas react with the reducing agent. In a water solution, a particular reaction of sodium hyposulfite and a chloramine, such as monochloramine, is:
NH₂Cl+2Na₂S₂O₃+H₂O=NaCl+Na₂S₄O₆+NaOH+NH₃ Equation 1.

Chlorine is reduced to chloride by the sodium hyposulfite as in Equation 2:
Cl₂+2Na₂S₂O₃=2NaCl+Na₂S₄O₆ Equation 2.

As seen in Equations 1 and 2, the gaseous chloramines and chlorine react with the sodium hyposulfite resulting in sodium chloride (NaCl), sodium tetrathionate (Na₂S₄O₆), and sodium hydroxide (NaOH, Equation 1). These resulting compounds stay in solution with the water and exit scrubbing unit 110 through outlet 116, and are thus separated from the hydrogen gas which exit scrubbing unit 110 through outlet supply line 115. Upon exiting scrubbing unit 110, chlorine and chloramines are at least partially removed, and the hydrogen gas may have less than about 0.01 ppm chlorine and less than about 0.01 ppm chloramines contained within the hydrogen gas. To avoid any water droplets containing the reducing agent or any reaction products from flowing with the hydrogen gas and into the ammonia removal process 20, the hydrogen gas is flowed through demister pads 117. Illustratively, the demister pads 117 may be fabricated from knitted wire of stainless steel, polypropylene, high density polyethylene or nylon.

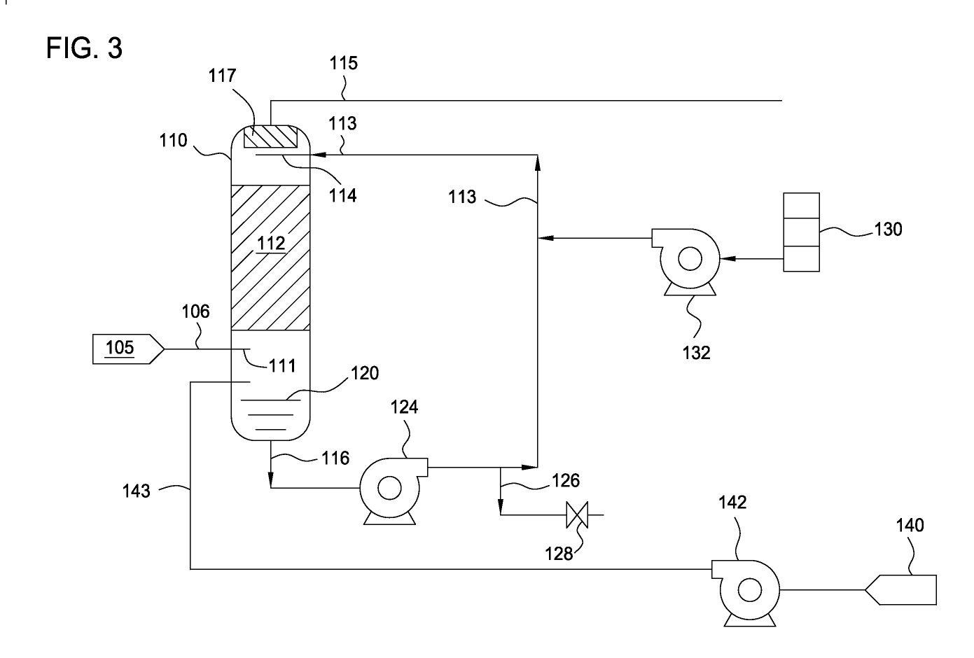

FIG. 3 depicts more details of process 10, according to one embodiment of the invention. Water is supplied from water source 140, and is pumped by water pump 142 through water supply line 143 into scrubbing unit 110. In one embodiment the water is demineralized. Pump 142 is controlled to keep a constant fluid level 120 in the bottom of scrubbing unit 110. Outlet line 116 removes the fluid from the bottom of scrubbing unit 110, and pump 124 pumps the fluid to supply line 113 and through liquid distributor 114. The reducing agent is stored in storage tank 130. Concentrated reducing agent is stored under an inert gas to prevent any potential oxidation of the reducing agent in air. In one embodiment the inert gas is nitrogen. In one embodiment the reducing agent solution is also stabilized by sodium hydroxide, sodium sulfite, or sodium carbonate to keep the solution neutral or slightly basic and to prevent sodium hyposulfite from decomposing into sulfite, sulfur, and sulfur dioxide. Dosage pump 132 pumps the reducing agent from storage tank 130 and dilutes it into the fluid of supply line 113. After the reducing agent solution has been used in the chlorine and chloramines removal process 10, the solution is recycled through outlet line 116. Part of the solution is removed from the solution cycle in waste line 126 in order to keep the concentration of reaction products sodium chloride, sodium hydroxide, and sodium tetrathionate low enough to avoid precipitation and flaking causing fouling and plugging. The amount of solution removed through waste line 126 is controlled by valve 128. The solution is monitored by measuring the pH values and oxidation reduction potentials of the solution at various locations of the fluid cycle. The measurements are used to determine whether valve 128 needs to be opened to remove any reaction products such as sodium chloride, sodium hydroxide, and sodium tetrathionate.

As seen in Equation 1, the reaction of sodium hyposulfite with the chloramines produces ammonia. The ammonia formed, or a fraction of the ammonia formed, escapes the solution and flows with the hydrogen gas. It is therefore beneficial that, in at least one embodiment, the chlorine and chloramines removal process 10 is performed before the ammonia removal process 20. However, in one embodiment the hydrogen gas does not pass through ammonia removal process 20 after coming out of the chlorine and chloramines removal process 10. In this embodiment, after coming out of the chlorine and chloramines removal process 10, the hydrogen gas may be used in downstream processes where the presence of ammonia in the hydrogen gas may be acceptable, or where there are alternative methods for removing the ammonia in the downstream process.

In ammonia removal process 20 the hydrogen gas is flowed into contact with an aqueous solution of an acid. The acid may be any compound that will combine with ammonia to form stable, harmless compounds. In an embodiment the acid is phosphoric acid (H₃PO₄). In another embodiment the acid is sulfuric acid (H₂SO₄). In one embodiment, the acid solution has a concentration range between about 1 mole % and about 30 mole %, preferably, between about 5 mole % and about 20 mole %. In a particular embodiment the acid concentration is about 10 mole %. The optimal acid concentration is determined by the maximum concentration of ammonia in the hydrogen feed gas. The acid solution is introduced into scrubbing unit 210 through supply line 213 and liquid distributor 214. The liquid distributor 214 directs the acid solution onto a packing material 212. The hydrogen gas is introduced via outlet supply line 115, coming out of scrubbing unit 110, and through inlet tip 211 into the scrubbing unit 210. In one embodiment, inlet tip 211 may be in the form of a diffuser. The hydrogen gas flows through the packing material 212 and comes into contact with the acid solution so that the ammonia gas flowing with the hydrogen gas reacts with the acid. The primary reaction of ammonia with the sulfuric acid forms ammonium sulfate:
2NH₃+H₂SO₄=(NH₄)₂SO₄ Equation 3.

In addition to ammonium sulfate, some ammonium bisulfate (NH₄HSO₄) may also be formed by the reaction. Both the ammonium sulfate and ammonium bisulfate stay in solution with the water and exit scrubbing unit 210 through outlet 216, and are thus separated from the hydrogen gas which exit scrubbing unit 210 through a second set of demister pads 217 and outlet supply line 215. Upon exiting scrubbing unit 210, ammonia is at least partially removed, and the hydrogen gas may have less than about 0.1 ppm ammonia contained within the hydrogen gas.

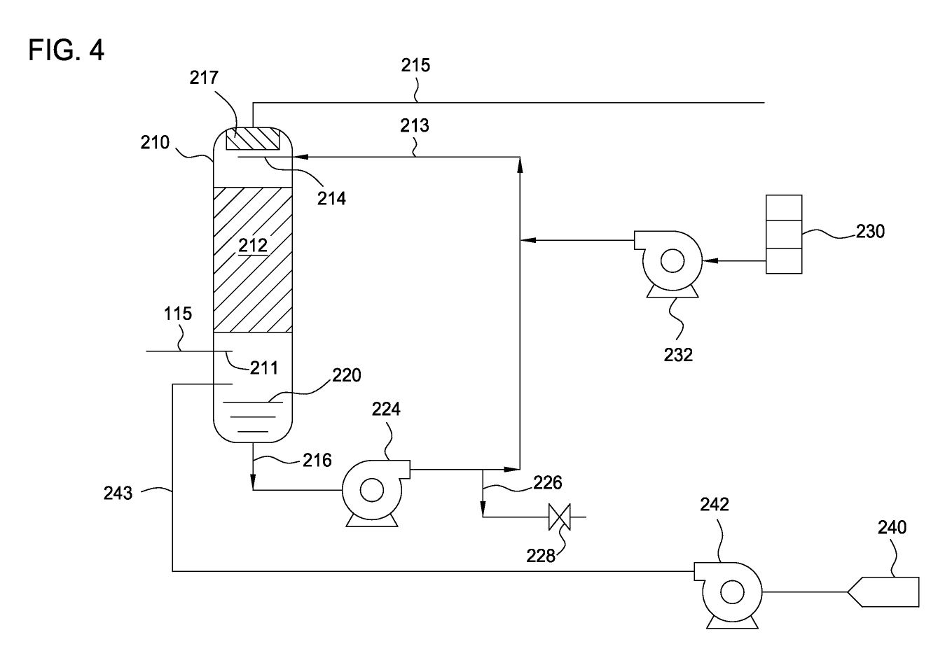

FIG. 4 depicts more details of process 20, according to one embodiment of the invention. Water is supplied from water source 240, and is pumped by water pump 242 through water supply line 243 into scrubbing unit 210. In one embodiment the water is demineralized. Pump 242 is controlled to keep a constant fluid level 220 in the bottom of scrubbing unit 210. Outlet line 216 removes the fluid from the bottom of scrubbing unit 210, and pump 224 pumps the fluid to supply line 213 and through liquid distributor 214. Concentrated acid is stored in storage tank 230. Dosage pump 232 pumps the concentrated acid from storage tank 230 and dilutes it into the fluid of supply line 213. After the acid solution has been used in the ammonia removal process 20 the solution is recycled through outlet line 216. Parts of the solution are removed from the solution cycle in waste line 226 in order to keep the concentration of reaction products such as ammonium sulfate and ammonium bisulfate low enough to avoid precipitation and flaking. The amount of solution removed through waste line 226 is controlled by valve 228. The solution is monitored by measuring the pH values of the solution at various locations of the fluid cycle. The measurements are used to determine whether valve 228 needs to be opened to remove ammonium sulfate and ammonium bisulfate.

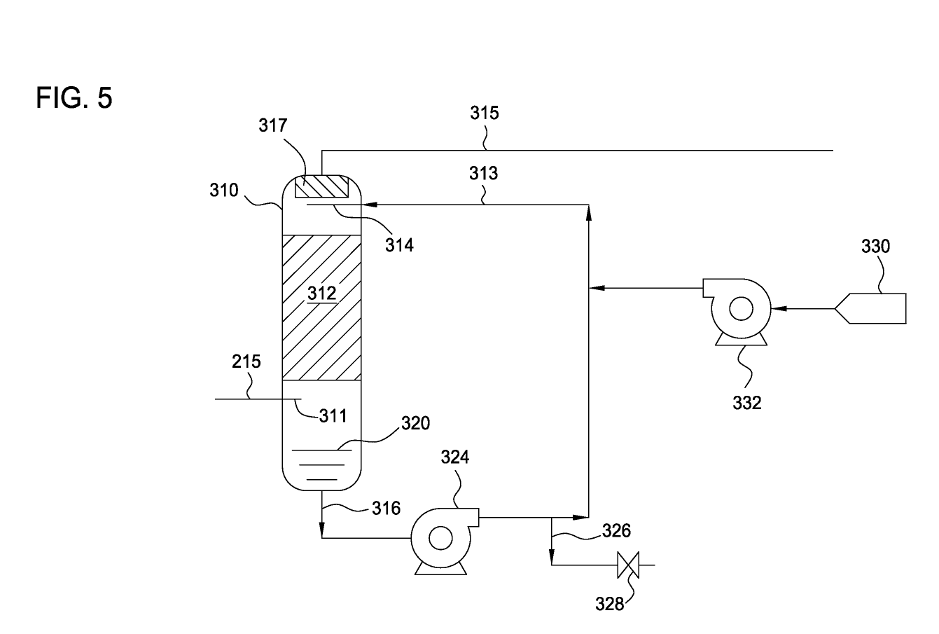

For some down stream processes it may be important to ensure complete removal of any traces of acid from the hydrogen stream leaving the ammonia removal process 20. Accordingly, acid removal process 30 is an optional process for removing any potential acid not trapped by demister 217 of process 20. FIG. 5 depicts acid removal process 30, according to an embodiment of the invention. Hydrogen gas, having exited ammonia removal process 20 through outlet supply line 215, is introduced to scrubbing unit 310 through inlet tip 311. Demineralized water is supplied from water source 330 and pumped by pump 332 through supply line 313 to liquid distributor 314 within scrubbing unit 310. The liquid distributor 314 directs the water onto a packing material 312. The hydrogen gas flows through the packing material 312 and comes into contact with the water so that the acid flowing with the hydrogen gas is absorbed by the water. The hydrogen gas then passes through demister 317 to remove any droplets of water before the hydrogen gas is passed through outlet supply line 315 for further down stream processing. The water, having passed the packing material 312 accumulates in the bottom of scrubbing unit 310 and is kept at a constant level 320. Excess water is recycled through outlet line 316 at a rate controlled by pump 324 to supply line 313. The water is monitored by measuring the pH values of the water at various locations of the water cycle. The water is removed from the cycle through waste line 326. The amount of water removed through waste line 326 is controlled by valve 328 to ensure no acidity in the water cycle. In an embodiment of the invention, the acidic waste water of process 30 is used as the water source 240 for ammonia removal process 20.

In another embodiment of the invention, acid removal may be obtained by using a high efficiency demister 217 in addition to a liquid distributor 214 having a design so as not to create excessive mist. In one embodiment, liquid distributor 214 is a trough type distributor.

Another embodiment of the invention includes an optional process which is used to monitor the efficiency of the purification process 100. In this embodiment, the hydrogen gas, having been exposed to process 100, is fed by outlet supply line 315 to a vessel packed with activated carbon. Activated carbon adsorbs any potential residual chlorine and chloramines not removed by process 100. In a preferred embodiment, the activated carbon is impregnated with potassium hydroxide (KOH) to adsorb traces of acid. The level of any potential chlorine and chloramines is continuously monitored so as to avoid accumulation of chloramines to a concentration above about 3% in order to avoid violent reactions.

In another embodiment of the invention, scrubbing units 110, 210, and 310 may be combined into a single unit containing the individual scrubbing units for removing chorine and chloramines, ammonia, and acid as described above. In another embodiment of the invention, scrubbing unit 110 may be kept separate and scrubbing units 210 and 310 may be combined into a single unit containing the individual scrubbing units for ammonia and acid as described above.

### EXAMPLES

In an embodiment of the invention, water saturated hydrogen gas with 19.9 ppm ammonia, 1.5 ppm chlorine, and 1.5 ppm monochloramine is flowed through inlet tip 111 into scrubbing unit 110 at a rate of 623 kg/hour, a pressure 1.5 bars absolute, and at 32° C. Scrubbing unit 110 has a 3.0 feet diameter and a height of 30 feet. A 0.5 mole % solution of sodium hyposulfite is flowed at a rate of 19000 kg/hour out of liquid distributor 114. Scrubbing unit 210 has a 2.5 feet diameter and a height of 30 feet. A 10 mole % solution of sulfuric acid is flowed at a rate of 23636 kg/hour out of liquid distributor 214. Scrubbing unit 310 has a 3.0 feet diameter and a height of 10 feet. Demineralized water is flowed at a rate of 8075 kg/hour out of liquid distributor 314. Upon exiting scrubbing unit 310, the hydrogen gas has less than about 0.01 ppm chlorine, less than about 0.01 ppm chloramines, and less than about 0.1 ppm ammonia contained within the hydrogen gas.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

What is claimed is:

1. A method for removing impurities from hydrogen gas, comprising:
a) passing the hydrogen gas through a first scrubbing unit comprising a reducing agent in solution to at least partially remove chlorine and chloramines from the hydrogen gas, wherein the first scrubbing unit comprises a first inlet for receiving the hydrogen gas and a first enclosure in which the hydrogen gas contacts the solution having the reducing agent.

2. The method of claim 1, further comprising:
b) passing the hydrogen gas from the first scrubbing unit through a second scrubbing unit comprising an acid in solution to at least partially remove ammonia from the hydrogen gas, wherein the second scrubbing unit comprises a second inlet for receiving the hydrogen gas and a second enclosure in which the hydrogen gas contacts the solution having the acid.

3. The method of claim 2, further comprising:
c) passing the hydrogen gas from the second scrubbing unit through a third scrubbing unit comprising water to at least partially remove acid from the hydrogen gas, wherein the third scrubbing unit comprises a third inlet for receiving the hydrogen gas and a third enclosure in which the hydrogen gas contacts the water.

4. The method of claim 3, wherein the water is demineralized.

5. The method of claim 3, wherein the reducing agent is selected from the group consisting of sodium metabisulfite, sodium sulfite, and sodium hyposulfite.

6. The method of claim 5, wherein the acid is selected from the group consisting of phosphoric acid and sulfuric acid.

7. The method of claim 6, wherein the reducing agent is sodium hyposulfite and the acid is sulfuric acid.

8. The method of claim 5, wherein the reducing agent has a concentration between about 0.1 mole % and about 10 mole %.

9. The method of claim 6, wherein the acid has a concentration between about 1 mole % and about 30 mole %.

10. The method of claim 2, wherein the scrubbing units further comprise a packing material.

11. The method of claim 10, wherein the packing material comprises polypropylene.

12. The method of claim 10, wherein the packing material is ring shaped.

13. The method of claim 12, wherein the packing material has a diameter between about 1 inch and about 3 inches.

14. The method of claim 2, further comprising
d) passing the hydrogen gas through a first demister pad after the chlorine and chloramines removal and before the ammonia removal; and
e) passing the hydrogen gas through a second demister pad after the ammonia removal.

15. The method of claim 3, further comprising
d) passing the hydrogen gas through a first demister pad after the chlorine and chloramines removal and before the ammonia removal;
e) passing the hydrogen gas through a second demister pad after the ammonia removal and before the acid removal; and
f) passing the hydrogen gas through a third demister pad after the acid removal.

16. The method of claim 1, wherein the hydrogen gas has an initial pressure between about 1 bar absolute and about 3 bar absolute.

17. The method of claim 1, wherein the hydrogen gas has a flow rate between about 40 kg/hour and about 1800 kg/hour.

18. The method of claim 2, further comprising contacting the hydrogen gas with activated carbon.

19. The method of claim 18, wherein the activated carbon is impregnated with potassium hydroxide.

20. The method of claim 3, further comprising contacting the hydrogen gas with activated carbon.

21. A method for removing impurities from hydrogen gas, comprising:
a) contacting the hydrogen gas with a reducing agent in aqueous solution to at least partially remove chlorine and chloramines from the hydrogen gas, wherein the reducing agent is selected from the group comprising sodium metabisulfite, sodium sulfite, and sodium hyposulfite.

22. The method of claim 21, further comprising:
b) contacting the hydrogen gas after the chlorine and chloramines removal with an acid in aqueous solution to at least partially remove ammonia from the hydrogen gas, wherein the acid is selected from the group consisting of sulfuric acid and phosphoric acid.

23. The method of claim 22, further comprising:
c) contacting the hydrogen gas after the ammonia removal with demineralized water to at least partially remove acid from the hydrogen gas.

24. The method of claim 21, wherein the reducing agent is sodium hyposulfite.

25. The method of claim 22, wherein the acid is sulfuric acid.

26. The method of claim 22, wherein the hydrogen gas comprises about 0.01 parts per million or less of chlorine, about 0.01 parts per million or less of chloramines, and about 0.1 parts per million or less of ammonia after the contacting with the reducing agent and the acid.

27. The method of claim 24, wherein the sodium hyposulfite has a concentration between about 0.1 mole % and about 1 mole %.

28. The method of claim 25, wherein the sulfuric acid has a concentration between about 5 mole % and about 20 mole %.

29. The method of claim 23, further comprising:
c) passing the hydrogen gas through a first demister pad after the contacting with the reducing agent and before the contacting with the acid;
d) passing the hydrogen gas through a second demister pad after the contacting with the acid and before the contacting with the water; and
e) passing the hydrogen gas through a third demister pad after the contacting with the water.

30. The method of claim 21, wherein the hydrogen gas has an initial pressure between about 1 bar absolute and about 3 bar absolute.

31. The method of claim 21, wherein the hydrogen gas has a flow rate between about 400 kg/hour and about 800 kg/hour.

32. The method of claim 22, further comprising contacting the hydrogen gas with activated carbon.

33. The method of claim 32, wherein the activated carbon is impregnated with potassium hydroxide.

34. A method for removing chlorine, chloramines, and ammonia impurities from hydrogen gas, comprising:
a) contacting the hydrogen gas with an aqueous sodium hyposulfite solution to at least partially remove chlorine and chloramines from the hydrogen gas;
b) after removing the chlorine and chloramines, passing the hydrogen gas through a first demister pad;
c) after passing through the first demister pad, contacting the hydrogen gas with an aqueous sulfuric acid solution to at least partially remove ammonia from the hydrogen gas;
d) after removing the ammonia, passing the hydrogen gas through a second demister pad;
e) after passing through the second demister pad, contacting the hydrogen gas with demineralized water to at least partially remove acid from the hydrogen gas; and
f) passing the hydrogen gas after acid removal through a third demister pad; wherein after passing the third demister pad the hydrogen gas comprises about 0.01 parts per million or less of chlorine, about 0.01 parts per million or less of chloramines, and about 0.1 parts per million or less of ammonia.

35. A system for removing chlorine, chloramines, and ammonia impurities from hydrogen gas, comprising:
a) a chlorine and chloramines scrubbing unit comprising:
i) a first packing material;
ii) a first hydrogen gas inlet tip to receive the hydrogen gas from a hydrogen source;
iii) a first liquid distributor adapted to direct a reducing agent in aqueous solution onto the first packing material, wherein the hydrogen gas is contacted with the reducing agent on the packing material to at least partially remove chlorine and chloramines from the hydrogen gas; and
iv) a first hydrogen gas outlet supply line to output the hydrogen gas after having been contacted with the reducing agent to at least partially remove the chlorine and chloramines from the hydrogen gas; and
b) an ammonia scrubbing unit comprising:
i) a second packing material;
ii) a second hydrogen gas inlet tip, wherein the second gas inlet tip is in fluid communication with the first hydrogen gas outlet supply line to receive the hydrogen gas;
iii) a second liquid distributor adapted to direct an acid in aqueous solution onto the second packing material, wherein the hydrogen is contacted with the acid on the packing material to at least partially remove ammonia from the hydrogen gas; and
iv) a second hydrogen gas outlet supply line to output the hydrogen gas after having been contacted with the acid to at least partially remove the ammonia from the hydrogen gas

36. The system of claim 35, further comprising:
c) an acid scrubbing unit comprising:
i) a third packing material;
ii) a third hydrogen gas inlet tip, wherein the third gas inlet tip is in fluid communication with the second hydrogen gas outlet supply line to receive the hydrogen gas;
iii) a third liquid distributor adapted to direct water onto the third packing material, wherein the hydrogen is contacted with the water on the packing material to at least partially remove acid from the hydrogen gas; and
iv) a third hydrogen gas outlet supply line to output the hydrogen gas after having been contacted with the water to at least partially remove the acid from the hydrogen gas

37. The system of claim 36, further comprising:
d) a first demister pad located between the first packing material and the first hydrogen gas outlet supply line;
e) a second demister pad located between the second packing material and the second hydrogen gas outlet supply line; and
f) a third demister pad located between the third packing material and the third hydrogen gas outlet supply line.

38. The system of claim 37, further comprising:
g) a first water supply line entering the a chlorine and chloramines scrubbing unit; and
h) a second water supply line entering the a ammonia scrubbing unit.

39. The system of claim 38, further comprising:
i) a first outlet line for removing solution from the chlorine and chloramines scrubbing unit;
j) a second outlet line for removing solution from the ammonia scrubbing unit; and
k) a third outlet line for removing water from the acid scrubbing unit.

40. The system of claim 39, further comprising:
l) a reducing agent solution cycle comprising:
i) the first outlet line for removing spent solution from the chlorine and chloramines scrubbing unit;
ii) a first pump for pumping the spent solution in the first outlet line;
iii) a reducing agent reservoir fluidly coupled to the first outlet line via a second pump; and
iv) a supply line fluidly coupled to the first outlet line for supplying the first liquid distributor with the reducing agent;
m) an acid solution cycle comprising:
i) the second outlet line for removing spent solution from the ammonia scrubbing unit;
ii) a third pump for pumping the spent solution in the second outlet line;
iii) an acid reservoir fluidly coupled to the second outlet line via a fourth pump; and
iv) a supply line fluidly coupled to the second outlet line for supplying the second liquid distributor with the acid; and
n) a water cycle comprising:
i) the third outlet line for removing spent water from the acid scrubbing unit;
ii) a fifth pump for pumping the spent water in the second outlet line;
iii) a water source fluidly coupled to the third outlet line via a sixth pump; and
iv) a supply line fluidly coupled to the third outlet line for supplying the third liquid distributor with the water.

41. The system of claim 40, further comprising:
o) a waste line fluidly coupled to the first outlet line for removing the spent reducing agent solution from the reducing agent solution cycle;
p) a waste line fluidly coupled to the second outlet line for removing spent acid solution from the acid solution cycle; and
q) a waste line fluidly coupled to the third outlet line for removing spent water from the water solution cycle.

42. The system of claim 36, further comprising:
d) an adsorption unit comprising activated carbon, wherein the third hydrogen gas outlet supply line feeds the hydrogen gas to the adsorption unit.

43. The system of claim 42, wherein the activated carbon is impregnated with potassium hydroxide.
